(19) United States
(12) Patent Application Publication
(10) Pub. No.: US 2005/0041799 A1
(43) Pub. Date: Feb. 24, 2005

(54) Method and system for classifying network connections

(76) Inventors: Frederic Pythoud, Fribourg (CH); Rolf Schenker, Gumligen (CH); Hans Friederich, Utzigen (CH)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/495,570

(22) PCT Filed: Nov. 16, 2001
(86) PCT No.: PCT/CH01/00677

(51) Int. Cl. H04M 1/00; H04M 9/00

(52) U.S. Cl. 379/400

(57) ABSTRACT

Method and device for classifying network connections based on geographical coordinates of a transmitter and a receiver of a network connection to be classified. By a calculating unit, one or more distance factors are determined, the distance factors indicating actual network connection length according to air distance. An attenuation distribution factor is determined based on known data of network connections, indicating the ratio of attenuation of different partial connection elements of a network connection in relation to one another. Further, data transfer margins are determined to calculate maximum data throughput rates for different modem types. Based on the actual connection length, the attenuation distribution factor, and the data transfer margin, the network connection is classified, according to its maximum throughput rate, by the calculating unit. In particular, the method can be applied to networks based on copper-wire connections, for example the last mile in telephone networks.

The present invention relates to a method and system for classifying network connections, in which method and system the geographical beginning and end coordinates of a network connection to be classified between a transmitter and a receiver are known. In particular the method relates to networks based on copper wire connections such as e.g. the last mile in telephone networks.

Traditional telephone network services, also called POTS (Plain Old Telephone Service), usually connect households and smaller enterprises to a distribution station of the telephone network operator via copper wires which are wrapped around each other and are called twisted pairs. These were originally intended for ensuring analog signals, in particular sound and voice transmissions. These requirements have however changed, at the latest with the emergence of the Internet and the data flow connected therewith, and are rapidly changing once again today, owing to the need to be able to work at home and/or in the office with real time and multimedia applications.

Data networks, such as e.g. Intranet and Internet, rely heavily on so-called shared media, i.e. on packet-oriented LAN (Local Area Network) or WAN (Wide Area Network) technologies both for broadband backbone between switches and gates and for local network connections with smaller bandwidths. Use of packet manager systems, such as e.g. bridges or routers, are widespread for connecting the local LAN networks to the Internet. An Internet router must thereby be capable of transmitting packets accordingly, based on the most varied protocols, such as e.g. IP (Internet Protocol), IPX (Internet Packet eXchange), DECNET, AppleTALK, OSI (Open System Interconnection), SNA (IBM's Systems Network Architecture) etc. The complexity of such networks, in order to be able to distribute the packets worldwide, is a challenge both for the vendor of services (provider) and for the manufacturer of the necessary hardware.

The ordinary LAN systems work relatively well with data transfer rates of about 100 Mbps. With transfer rates above 100 Mbps, the resources of the network manager, such as packet switches, do not suffice in most of today's networks for administering the allocation of bandwidths and of user access. Of course the usefulness of packet-based networks for transmission of digital information, in particular with short-term transmission peaks, was recognized long ago. Such networks usually have point-to-point structure, a packet being transmitted from a single transmitter to a single receiver in that each packet comprises at least the destination address. A typical example of this is the known header of an IP data packet. The network reacts to the data packet by routing the packet to the address of the assigned header. Packet-based networks can also be used for transmitting data types requiring a continuous data flow, such as e.g. sound and audio transmissions of high quality or video transmissions. The commercial use of networks makes it particularly desirable for packet-based transmission to be also possible simultaneously to a plurality of end points. An example of this is the so-called packet broadcasting for transmission of video or audio data. So-called pay TV can thereby be achieved, i.e. broadcast transmission, liable to charges, of video data over the network.

With the next generation of applications, such as real-time and multimedia applications with their much bigger requirement with respect to bandwidth, which must be guaranteed moreover at any time, the packet-oriented networks meet their limits, however. Thus a next generation of networks should possess the possibility of reconfiguring the networks dynamically in order to be able to always guarantee the user a predefined bandwidth for requested or agreed-upon QoS Parameters (Quality of Service). These QoS comprise e.g. access guarantee, access performance, fault tolerance, data security, etc. between all possible end systems. New technologies, such as e.g. ATM (Asynchronous Transfer Mode), should help to create in the long-term development of the networks the necessary prerequisites for the private Intranet as well as the public Internet. These technologies promise a more economical and more scalable solution for such high performance connections guaranteed by means of QoS parameters.

One change for future systems will also relate in particular to the data flow. The data flow today is usually based on a server-client model, i.e. data are transmitted from many clients to or from one or more network servers. The clients create normally no direct data connection, but instead they communicate with each other via network servers. This type of connection will also continue to have its significance. Nevertheless it is to be expected that the quantity of data which is transmitted peer-to-peer will increase sharply in the future since, in order to meet the demands, the ultimate goal of the networks will be a truly decentralized structure in which all systems are able to act both as server and as client. Thus the network will have to generate more direct connections to the different peers, whereby e.g. desktop computers will be connected directly via the backbone Internet.

It is therefore clear that in future applications it will become more and more important for the user to be able to be guaranteed predeterminable QoS parameters and large bandwidths.

Used for data transmission to the end user are in particular the traditional public telephone network (PSTN: Public Switched Telephone Network) and/or PLMN (Public Land Mobile Network), which were actually designed originally for pure sound transmission, and not for transmission of such quantities of digital data. The so-called “last mile” plays a decisive role thereby in the determination of the QoS parameters which a provider or vendor of telephone services is able to guarantee the user. Designated as the last mile is the stretch between the last distribution station of the public telephone network and the end user. In the fewest cases the last mile consists of high-capacity fiber optic cables. It is usually based rather on the ordinary copper wire cabling, such as e.g. cable with 0.4 or 0.6 mm wire diameter. The cables moreover are not run everywhere underground in protected ground conducting construction, but also consist of overland lines to telephone masts, among other things. Additional disturbances thereby arise.

A further problem in determining the maximal QoS parameters is the so-called crosstalk problem. This problem arises with the modulation of the signal on the line e.g. from the end user to the distribution station of the telephone network operator and vice-versa. Known in the state of the art for modulation of digital signals are e.g. the xDSL technologies (Digital Subscriber Line), such as ADSL (Asymmetric Digital Subscriber Line), SDSL (Symmetric Digital Subscriber Line), HDSL (High-data-rate DSL) or VDSL (Very high speed Digital Subscriber Line). The mentioned crosstalk is the physical phenomenon which arises during the modulation of data via a copper cable. By way of electromagnetic interaction, adjacent copper wires inside a copper cable obtain partial signals pairwise which are generated by the modem. This results in xDSL modems, carried on adjacent wires, interfering with one another. A distinction is made between Near End Crosstalk (Next), which characterizes the undesired signal coupling of signals of the transmitter at one end to the signals of the receiver at the same end, and Far End Crosstalk (FEXT), which characterizes the undesired signal coupling of signals during the transmission to the receiver at the other end, the signals during the transmission being coupled to signals of adjacent copper wire pairs and showing up as noise at the receiver.

Although many studies on XDSL crosstalk are available today, such as e.g. “Spectral management on metallic access networks; Part 1: Definitions and signal library”, ETSI (European Telecommunications Standards Institute), TR 101 830, September 2000, there are at the present time few usable, technically easy-to-handle and cost-efficient aids for determining the QoS parameters for a particular end user in the network, owing to the complexity of the crosstalk phenomenon and of the remaining noise parameters. In the state of the art, remote measuring systems have been proposed by different companies, such as e.g. Acterna (WG SLK-11/12/22, Eningen, among others, Germany), Trend Communications (LT2000 Line Tester, www.trendcomms.com, Buckinghamshire, U.K.) etc. The maximal transfer rate over the last mile is thereby determined through direct measurements by means of remote measuring systems: a digital signal processor is installed at each local distribution station of a telephone network operator (e.g. in Switzerland several thousand). By means of the digital signal processor a so-called “single ended measurement” is carried out since no installations of devices are necessary at the user on the other side of the last mile. The measurements are also possible, in principle, by means of “double ended measurement.” Installation of measuring devices at both ends of the line are thereby necessary, however.

The drawbacks of the state of the art are, among other things, high costs from the required installation of remote measuring systems at every local distribution station and a imprecisely known incertitude or respectively unknown error during the measurement since the measurements are carried out only on one side (single ended) and measurements on both sides would be needed to determine the error. A two-sided measurement would not be feasible in view of the investment in personnel and in time as well the in costs. Also lacking in the state of the art are algorithms with their hardware or software implementation for calculation, or respectively prediction, of the maximal possible bit rates of a network connection. An installation of the remote measuring systems at the less numerous central distribution stations instead of at the local end distribution stations shows that the measurements entail such great uncertainties that they are not suitable for determining the maximal possible data throughput rates for a particular line to an end user.

It is an object of this invention to propose a new method and a device for classifying network connections, not having the drawbacks described above. In particular, QoS parameters and especially the maximal bit rate able to be guaranteed for a particular user can be determined quickly and flexibly without a disproportionate technical investment, investment in personnel and financial investment having to be made. This should also take place when the network comprises complicated connection structures, known only imprecisely, such as e.g. the last mile.

This object is achieved according to the present invention in particular through the elements of the independent claims. Further preferred embodiments follow moreover from the dependent claims and from the description.

In particular these objects are achieved through the invention in that, for classifying network connections, geographic coordinates of a transmitter and a receiver of a network connection to be classified are known, in that one or more distance factors are determined by means of a calculating unit based on known data of network connections and, assigned to a determinable probability, are transmitted onto a data carrier of the calculating unit, whereby the distance factors indicate the actual network connection length in dependence upon the air distance, and the determinable probability whether a determined network connection length is shorter or longer than its actual network length being established by means of a safety factor, in that the actual network connection length is determined by means of the calculating unit based on the one or more distance factors, the safety factor and the geographic coordinates of the transmitter and the receiver of the network connection to be classified, and is transmitted, assigned to the network connection to be classified, onto a data carrier of the calculating unit, in that at least one attenuation distribution factor is determined based on known data von network connections and is transmitted onto a data carrier of the calculating unit, whereby the at least one attenuation distribution factor indicates the ratio of attenuation of various partial connection elements of a network connection in relation to one another, in that data transfer margins for determining maximal data throughput rates for different modem types are determined and, assigned to a physical length and cable thickness of a network connection, are stored on a data carrier of the calculating unit, power spectra for the modem types being measured by means of a power measuring device, actual signal strengths and corresponding noise level are determined by means of calculating unit based on the power spectra, and the data transfer margins for a predefined bit rate are determined by means of Gaussian transformation module based on the signal strengths and the noise levels for different data transmission modulations and/or modulation codings and in that, based on the actual network connection length, attenuation distribution factor and the data transfer margins, the network connection to be classified is classified corresponding to its maximal data throughput rate by means of calculating unit. An advantage of the invention is, among other things, that the method and system permit for the first time a simple and quick determination of the data transfer margins, without an immense technical investment, investment in personnel and investment in time having to be thereby made. In particular, the uncertainties can be corrected by means of the mentioned correction, without, as with the remote measuring systems for measuring the data transfer margins and/or the bit rates, a different imprecisely known uncertainty at each local distribution station, or respectively unknown errors in measurement having to be corrected, which error is difficult to estimate owing to the single-endedness since measurements on both sides would be necessary for determining the error.

In an embodiment variant, a gradient factor and an abscissa are determined as distance factors by means of the calculating unit, a linear dependence between air distance and actual network connection length being determined. This embodiment variant has the advantage, among other things, that it suffices for most of the dependencies of network structures and can provide results within the necessary degree of accuracy. This is more than surprising to one skilled in the art since it cannot be expected that <for> such complex dependencies a linear function suffice <suffices> within the desired degree of accuracy. In particular linear dependencies <are> simpler and faster to determine and handle than non-linear.

In a further embodiment variant, the calculating unit determines the distance factors as parameter of a polynomial of at least the second order. This embodiment variant has the advantage, among other things, that it can reflect any degree of precision depending upon the order of the polynomial used and of the required maximal deviation for the dependency between air distance and actual network connection length. Surprising and unexpected however is that polynomials of a very high order are hardly necessary to meet the requirements of this method.

In another embodiment variant, using the safety factor, a probability is selected of between 0.85 and 0.95. This embodiment variant has the advantage, among other things, that the error rate and the maximal deviation is limited to a degree of accuracy necessary for the method and the device.

In an embodiment variant, the safety factor has a value between 700 and 800. The unit is meters (m) for this embodiment variant. This embodiment variant has, among other things, the same advantages as the preceding embodiment variant.

In a further embodiment variant, by means of an attenuation distribution factor, a linear dependency of the attenuations with respect to one another is determined. This embodiment has the advantage, among other things, that it suffices for most of the dependencies of network structures and can provide results within the required degree of accuracy. This is more than surprising to one skilled in the art since it cannot be expected that <for> such complex dependencies a linear function suffice <suffices> within the desired degree of accuracy. In particular linear dependencies <are> simpler and faster to determine and handle than non-linear. This embodiment variant applies in particular to networks with connections consisting of two different cables with different wire thicknesses, such as e.g. copper cable with 0.4 mm and 0.6 mm wire diameter.

In another embodiment variant, the calculating unit determines corrected data transfer margins by means of at least one correction factor based on the stored data transfer margins and stores them, assigned to the respective physical lengths and cable wire thicknesses of the network connection, on a data carrier of the calculating unit, the correction factor comprising an average deviation of the stored data transfer margins with respect to the actual data transfer margins. This embodiment variant has the advantage, among other things, that factors which cause an additional deviation of the determined data transfer margins with respect to the actual data transfer margins can be taken into account. Belonging thereto are e.g. deviations caused through a good or poor implementation of the modems by the manufacturer or through additional internal noise owing to quantization noise or a poor mutual adjustment of the equalizer.

In an embodiment variant, the noise level is determined based on the power spectra by means of calculating unit in dependency upon at least crosstalk parameters and number of interference sources.

In an again different embodiment variant, the at least one correction factor reflects a non-linear dependency with respect to the physical lengths and/or cable wire thicknesses, i.e. the correction factor can be represented by a non-linear function, e.g. a polynomial function of an order higher than 1. This embodiment variant has the advantage, among other things, that much more complex dependencies can be taken into consideration and corrected with it than with linear correction factors.

In an embodiment variant, the power spectrum is measured in dependence upon the transmission frequency for ADSL and/or SDSL and/or HDSL and/or and/or <sic.> VDSL modem types. The possible SDSL modem types can thereby comprise at least one G.991.2 modem type and/or the ADSL modem types at least one G.992.2 modem type. By means of the Gaussian transformation module the data transfer margins can be determined for at least the data transmission modulations 2B1Q and/or CAP and/or DMT and/or PAM. Also by means of the Gaussian transformation module the data transfer margins can be determined for at least the trellis modulation coding. This embodiment variant has the advantage, among other things, that with the xDSL modem types, the mentioned data transmission modulations and the trellis modulation coding, common standard technologies are used which are easily obtainable on the market and whose use are <sic. is> widespread both in Europe and also in the USA.

In particular these objects are achieved through the invention in that, for classifying network connections, geographic coordinates of a transmitter and a receiver of a network connection to be classified are known,

in that, by means of a calculating unit, based on known data of network connections, one or more distance factors are determined and, assigned to a determinable probability, are transmitted onto a data carrier of the calculating unit, the distance factors indicating the actual network connection length in dependence upon the air distance, and the determinable probability whether a determined network connection length is shorter or longer than its actual network length being established by means of a safety factor,

in that, based on the distance factors, the safety factor and the geographic coordinates of the transmitter and of the receiver of the network connection to be classified, the actual network connection length is determined by means of the calculating unit and is transmitted, assigned to the network connection to be classified, onto a data carrier of the calculating unit,

in that at least one attenuation distribution factor is determined, based on known data of network connections, and is transmitted onto a data carrier of the calculating unit, the at least one attenuation distribution factor indicating the ratio of attenuation of different partial connection elements of a network connection in relation to one another,

in that bit rates are determined for determining maximal data throughput rates for different modem types and, assigned to a physical length and cable thickness of a network connection, are stored on a data carrier of the calculating unit, power spectra being measured for the modem types by means of a power measuring device, actual signal strengths and corresponding noise level being determined by means of calculating unit based on the power spectra, and the bit rates for a predefined data transfer margin being determined by means of Gaussian transformation module based on the signal strengths and the noise level for different data transmission modulations and/or modulation codings,

and in that, based on the actual network connection length, attenuation distribution factor and the data transfer margins, the network connection to be classified is classified by means of calculating unit according to its maximal data throughput rate. This embodiment variant has, among other things, the advantage that the method and system permits for the first time a simple and quick determination of the bit rates, without having to thereby engage in an immense technical investment, investment with respect to personnel and investment with respect to time. In particular, the uncertainties can be corrected by means of the mentioned correction, without, as with the remote measuring systems for measuring the data transfer margins and/or the bit rates, a different imprecisely known uncertainty at each local distribution station, or respectively unknown errors in measurement having to be corrected, which errors are difficult to estimate owing to the single-endedness since measurements on both sides would be necessary for determining the error.

In an embodiment variant a gradient factor and an abscissa are determined as distance factors by means of the calculating unit, a linear dependency between air distance and actual network connection length being determined. This embodiment has the advantage, among other things, that is suffices for most dependencies of network structures and can provide results within the required degree of accuracy. This is more than surprising to one skilled in the art since it cannot be expected that <for> such complex dependencies a linear function suffice <suffices> within the desired degree of accuracy. In particular linear dependencies <are> simpler and faster to determine and handle than non-linear.

In a further embodiment variant, the calculating unit determines the distance factors as parameters of a polynomial of at least the 2^{nd} order. This embodiment variant has the advantage, among other things, that it can reflect any degree of precision depending upon the order of the polynomial used and of the required maximal deviation for the dependency between air distance and actual network connection length. Surprising and unexpected however is that polynomials of a very high order are hardly necessary to meet the requirements of this method.

In another embodiment variant, using the safety factor a probability between 0.85 and 0.95 is selected. This embodiment variant has the advantage, among other things, that the error rate and the maximal deviation is limited to a degree of accuracy necessary for the method and the device.

In an embodiment variant the safety factor has a value between 700 and 800. The unit is meters (m) for this embodiment variant. This embodiment variant has, among other things, the same advantages as the preceding embodiment variant.

In a further embodiment variant, by means of an attenuation distribution factor, a linear dependency of the attenuations with respect to one another is determined. This embodiment has the advantage, among other things, that it suffices for most of the dependencies of network structures and can provide results within the required degree of accuracy. This is more than surprising to one skilled in the art since it cannot be expected that <for> such complex dependencies a linear function suffice <suffices> within the desired degree of accuracy. In particular linear dependencies <are> simpler and faster to determine and handle than non-linear. This embodiment variant applies in particular to networks with connections consisting of two different cables with different wire thicknesses, such as e.g. copper cable with 0.4 mm and 0.6 mm wire diameter.

In another embodiment variant, the calculating unit determines corrected bit rates by means of at least one correction factor based on the stored bit rates and stores them, assigned to the respective physical lengths and cable wire thicknesses of the network connection, on a data carrier of the calculating unit, the correction factor comprising an average deviation of the stored bit rates with respect to the actual bit rates. This embodiment variant has the advantage, among other things, that factors which cause an additional deviation of the determined bit rates with respect to the actual bit rates can be taken into account. Belonging thereto are e.g. deviations caused through a good or poor implementation of the modems by the manufacturer or through additional internal noise owing to quantization noise (analog to digital conversion) or a poor mutual adjustment of the equalizer.

In an embodiment variant, the power spectrum is measured in dependence upon the transmission frequency for ADSL and/or SDSL and/or HDSL and/or and/or <sic.> VDSL modem types. The possible SDSL modem types can thereby comprise at least one G.991.2 modem type and/or the ADSL modem types at least one G.992.2 modem type. By means of the Gaussian transformation module the data transfer margins can be determined for at least the data transmission modulations 2B1Q and/or CAP and/or DMT and/or PAM. Also by means of the Gaussian transformation module the data transfer margins can be determined for at least the trellis modulation coding. This embodiment variant has the advantage, among other things, that with the XDSL modem types, the mentioned data transmission modulations and the trellis modulation coding, common standard technologies are used which are easily obtainable on the market and whose use are <sic. is> widespread both in Europe and also in the USA.

In a further embodiment variant, the correction factor reflects a non-linear dependency with respect to the physical lengths and/or cable wire thicknesses, i.e. the correction factor can be represented by a non-linear function, e.g. a polynomial function of an order higher than 1. This embodiment variant has the advantage, among other things, that much more complex dependencies can be taken into consideration and corrected with it than with linear correction factors.

In a further embodiment variant the bit rates for a data transfer margin between 3 and 9 dB are determined by means of the Gaussian transformation module. This embodiment variant has the advantage, among other things, that the range between 3 and 9 dB permits reception with QoS parameters fulfilling most requirements. In particular, the range of data transfer margins between 3 and 9 dB allows an optimization of the bit rate with respect to the other QoS parameters.

In a further embodiment variant, the bit rates for a 6 dB data transfer margin are determined by means of the Gaussian transformation module. This embodiment variant has the same advantages as the preceding embodiment variant. In particular, as above, a data transfer margin of 6 dB allows an optimization of the bit rate with respect to the other QoS parameters.

It should be stated here that, in addition to the method according to the invention, the present invention also relates to a device for carrying out this method.

Embodiment variants of the present invention will be described in the following with reference to examples. The examples of the embodiments are illustrated by the following attached figures:

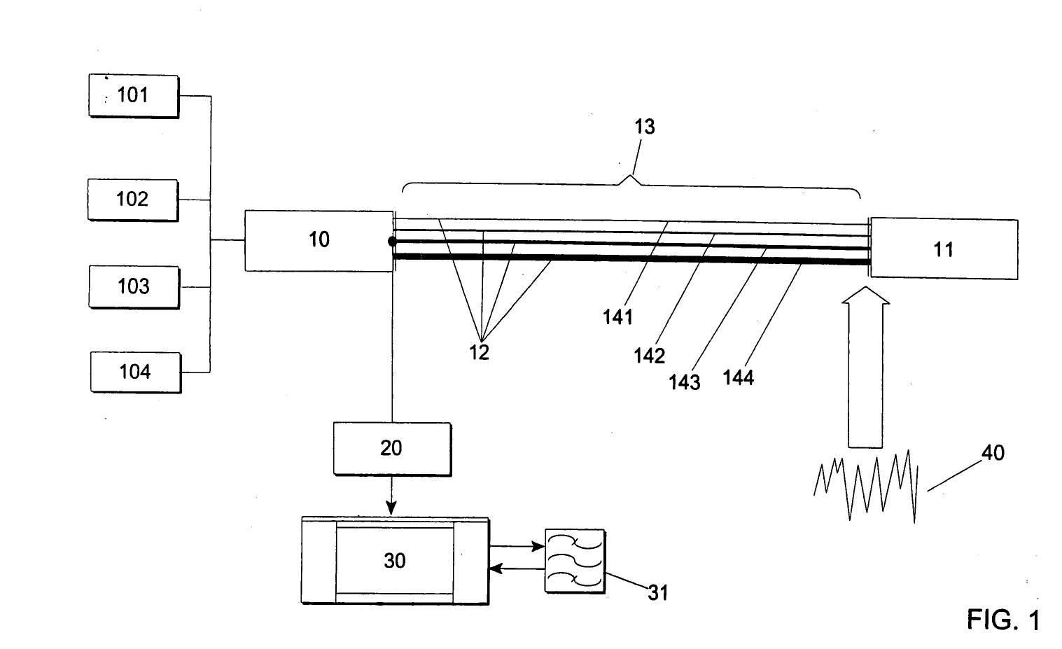

FIG. 1 shows a block diagram, indicating schematically the architecture of an embodiment variant of a system according to the invention for determining data transfer margins or respectively bit rates for a network connection 12 with a determined physical length 13 between a transmitter 10 and a receiver 11.

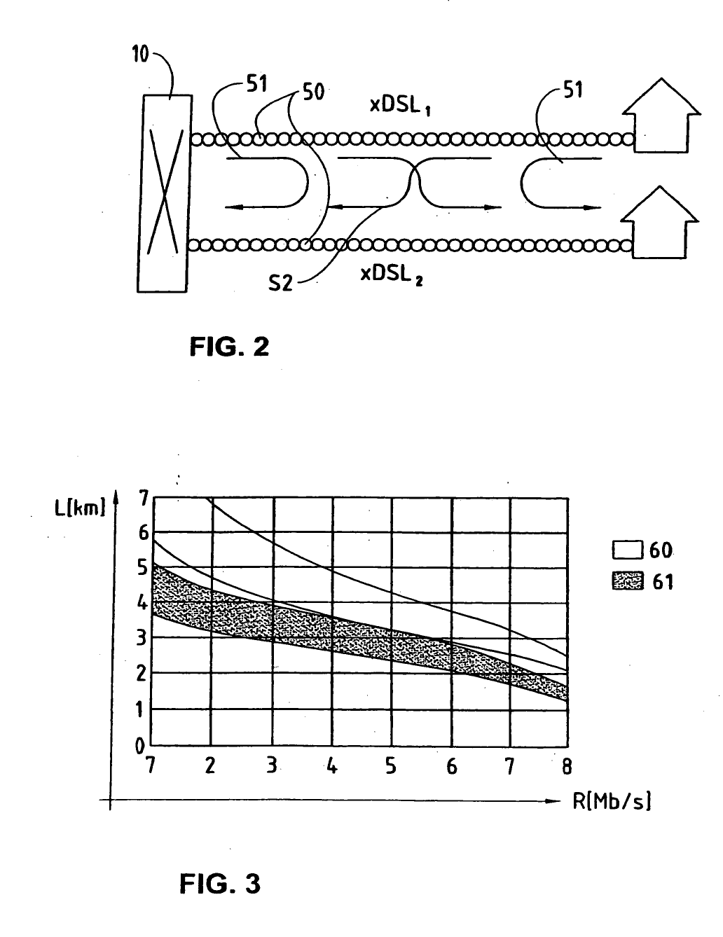

FIG. 2 shows schematically crosstalk interaction with near-end crosstalk (Next) 51, which describes the unwanted coupling of signals 50 of the transmitter 10 at one end to the signals 50 at the receiver 11 at the same end, and far-end crosstalk (FEXT) 52, which describes the unwanted coupling of signals 50 during transmission to the receiver 11 at the other end, whereby during the transmission the signals 50 couple with signals 50 of adjacent copper wire pairs and appear as noise at the receiver 11.

FIG. 3 shows schematically the transmission distance of the network connection in dependence upon the transmission rate (bit rate) for ADSL modems, as can be obtained with a system according to the invention. The reference numerals 60 and 61 thereby designate different noise environments.

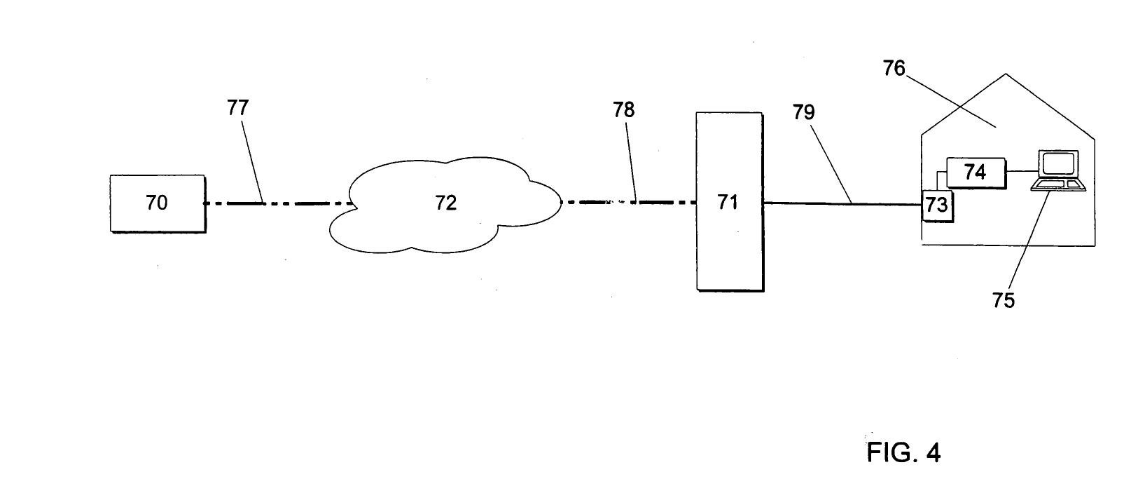

FIG. 4 shows schematically the so-called last mile of the public telephone network (PSTN: Public Switched Telephone Network), as typically exists between the end user at home and a network which is supposed to be reached via the public telephone network.

FIG. 5 shows a diagram of an example of a data sample for an existing network, the data sample comprising 200 000 measured network connections of the last mile of the telephone network.

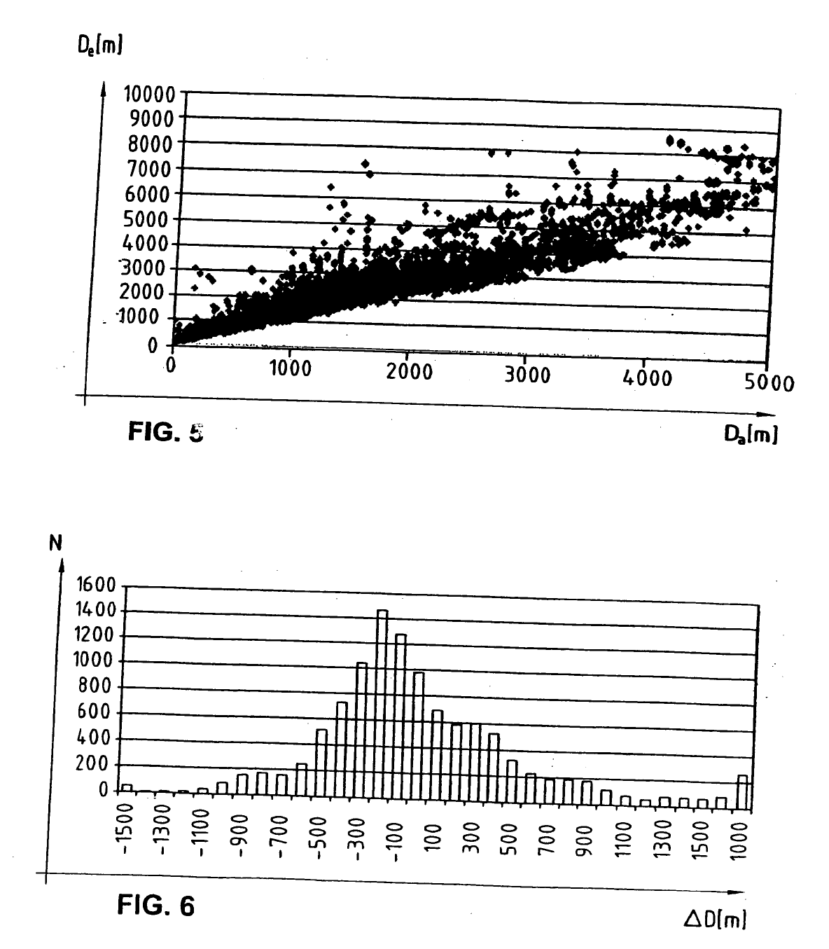

FIG. 6 shows a diagram with the average deviation of the actual network connection length Dₑ from the determined network connection length Dₐ. The X axis indicates the average deviation ΔD in meters and the Y axis the size of the data sample used, i.e. the number N of known network connections.

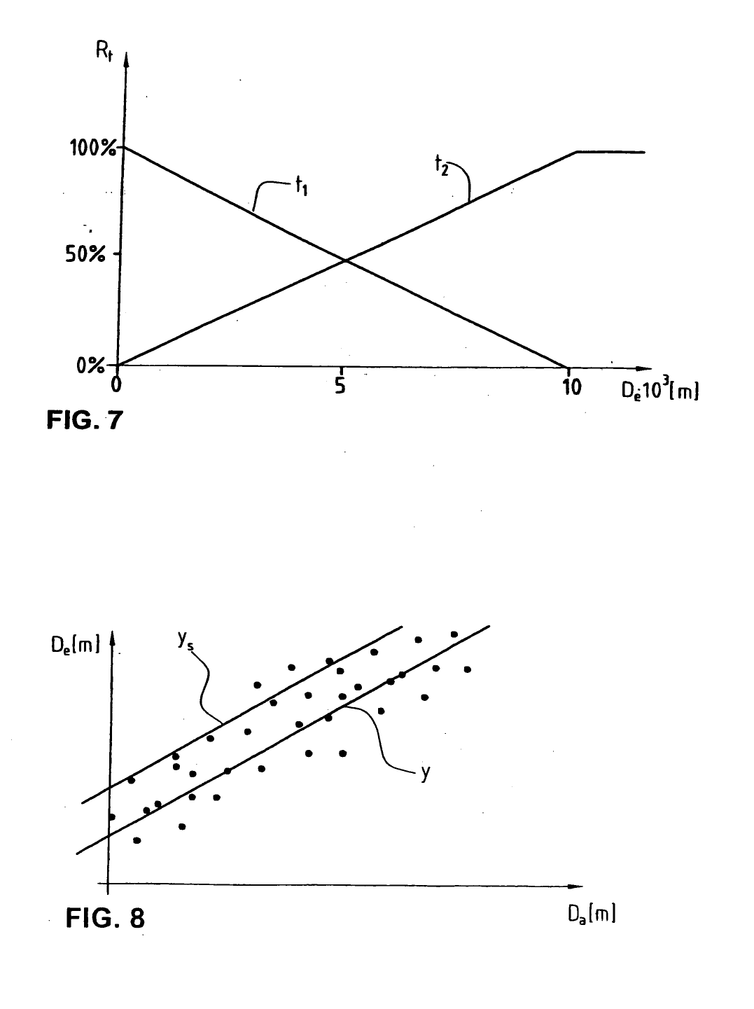

FIG. 7 shows schematically the ratio Rₜ of 0.4 mm copper cable t₁ to 0.6 mm copper cable t₂ on the last mile in the public telephone network. The X axis indicates the actual network connection length Dₑ, i.e. its physical length, and the Y axis the shares Rₜ of a respective cable type in percentage.

FIG. 8 shows a diagram of an example of a determination 2011/2012 of the one or more distance factors as well as of the safety factor. Analogous to FIG. 5, the X axis thereby indicates the actual network connection length Dₑ in meters and the Y axis the air distance of the network connections Dₐ. likewise in meters.

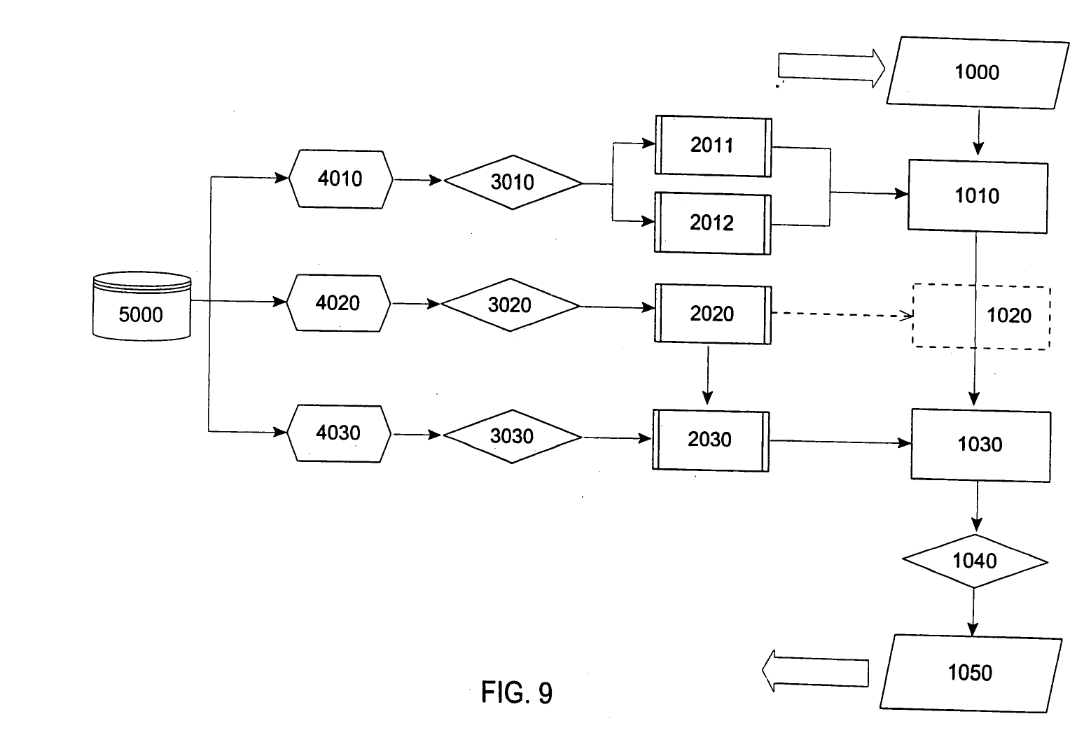

FIG. 9 shows schematically the course of a method according to the invention. The four-digit reference numbers refer in each case to FIG. 9.

FIG. 1 shows an architecture which can be used to achieve the invention. In this embodiment example for the method and the device for classifying network connections, the geographic coordinates are known 1000 of a transmitter 10 and a receiver 11 of a network connection 12 to be classified. The coordinates can be indicated e.g. in degrees of longitude and latitude with sufficient precision, but other coordinates or indications of location are also conceivable for designating the relative geographic position of transmitter 10 and receiver 11 to one another. In order to be able to determine e.g. whether a particular network connection, for instance an xDSL connection, functions for a point of access, the actual cable length must be known within a known margin of error. Often in practice, however, only the air distance can be determined at a reasonable expense (costs, time, personnel and material expenditure, etc.). On the basis of coordinate indications or location indications for the relative, geographic position of transmitter 10 and receiver 11, e.g. the air distance between transmitter 10 and receiver 11 is determined by means of a calculating unit 30. The air distance can be stored e.g. on a data carrier of the calculating unit 30. The calculating unit 30 determines 3010 one or more distance factors 2011 based on a data sample 4010 selected from known data 5000 on network connections. The course of the method according to the invention is shown schematically in FIG. 9, to which the four-digit numbers also refer. The data 5000 could be e.g. experimentally acquired data or data known otherwise about network connections, including the air distance and the actual, physical line length of these network connections. The distance factors 2011 are thus determined in dependence upon a probability, whereby the probability can be determinable, and describe the actual network connection length Dₑ in dependence upon the air distance Dₐ. Furthermore the distance factors 2011 can be transmitted, assigned to the determinable probability, onto a data carrier of the calculating unit 30. A gradient factor and an abscissa can be determined as distance factors 2011 by means of the calculating unit 30, a linear dependence being determined between air distance Dₐ and actual network connection length Dₑ. However, it is also possible, for example, to determine the distance factors 2011 as parameters of a polynomial of the 2^{nd} order or higher by means of the calculating unit 30. The determinable probability, which can be established by means of a safety factor 2012, indicates whether a determined network connection length is shorter or longer than its actual network length Dₑ. Using the safety factor, the probability can be selected between 0.85 and 0.95, for example. In the case of the last mile (see further below), with the mentioned probability, the safety factor can have e.g. a value of between 700 and 800, the unit thereby being meters (m).

FIG. 5 shows an example of a data sample for an existing network. The data sample comprises 200 000 measured network connections of the last mile (see further below). In this network the connections mainly consist of traditional telephone connections with copper cable of 0.4 mm and 0.6 mm wire diameter. Even though the complexity of such network structures would lead one skilled in the art to expect a more complicated dependency, the example shows a clear correlation. The X axis thereby indicates the actual network connection length Dₑ in meters and the Y axis the air distance of the network connections Dₐ, likewise in meters.

FIG. 8 shows an example for determining one or more distance factors 2011 and the safety factor 2012. Analogous to FIG. 5, the X axis thereby indicates the actual network connection length Dₑ in meters and the Y axis the air distance of the network connections Dₐ, likewise in meters. The data points can be selected 4010 e.g. from a data sample with known data 5000 of network connections. Determination of the distance factors 2011 as well as of the safety factor 2012 can take place, for example, by means of a FIT module. With this example a linear dependency was determined between air distance Dₐ and actual network connection length Dₑ, a gradient factor a and an abscissa b being determined as distance factors 2011 by means of the calculating unit 30. The abscissa b results through the different point of access locations (e.g. city, suburb, rural area, mountains) as well as through the different point of access areas (e.g. main distributing frame, distribution box, crossover points, etc.). The actual distance then results from: Dₑ=y=a Dₐ+b. For y, about 50% of the determined network connections are shorter than the actual network connections, i.e. with a probability of 0.5. The safety factor S 2012 was also selected to be linear, i.e. as a constant. Thus the outcome is Dₑ=yₛ=a Dₐ+b+S. The probability whether a determined network connection length is shorter or longer than its actual network length Dₑ can be determined by means of S. In the example shown with yₛ in FIG. 8, the probability was set at 0.9 by means of the safety factor S 2012. In the embodiment example, found for the gradient factor a=Dₑ/Dₐ for the last mile in the traditional telephone network was, for example, for city conditions aₛ=1.27, suburban conditions aᵥ=1.28, rural conditions aₗ=1.30 and mountain conditions: a_{g}=130. With a mixed data set (city, suburb, rural area, mountains) determined was aₐₗₗ=1.30. In an analogous way, in so doing, the outcome is for bₛ=200, bᵥ=355, bₗ=372, b_{g}=391 and bₐₗₗ=328, b being indicated in meters. The standard deviations σ for the embodiment example lie at σₛ=333, σᵥ=569, σₗ=682, σ_{g}=527 and σₐₗₗ=598. The standard deviation σ reflects the statistical spread of the differences between actual network connection length and determined network connection length. The average deviation in meters of the actual network connection length Dₑ from the determined network connection length Dₐ is approximately independent of the network connection length and is shown in FIG. 6 for the embodiment example. The X axis indicates the average deviation ΔD in meters and the Y axis the size of the data sample used, i.e. the number N of known network connections. To obtain a probability of 0.9, the outcome for the safety factor S for this embodiment example is e.g. Sₛ=360, Sᵥ=640, Sₗ=850, S_{g}=670 and Sₐₗₗ=730. However, to obtain a probability of 0.95, the outcome for the safety factor S for this embodiment example is Sₛ=490, Sᵥ=1100, Sₗ=1330, S_{g}=930 and Sₐₗₗ=1210.

Based on the one or more distance factors 2011 and the safety factors 2012, with reference to the geographic coordinates of the transmitter 10 and of the receiver 11 of the network connection 12 to be classified, the actual network connection length, i.e. its physical length, is determined 1010, by means of the calculating unit 30, and is transmitted, assigned to the network connection 12 to be classified, onto a data carrier of the calculating unit 30.

Meant by the physical length is the actual cable length, i.e. not for example the air distance, between the transmitter 10 and the receiver 11. The network connection 12 should be composed of an analog medium such as e.g. a copper wire cabling. Used in this embodiment example was, for instance, copper cable with 0.4 or 0.6 mm wire diameter, as is used typically in the last mile of the public telephone network (PSTN: Public Switched Telephone Network). The last mile is shown schematically in FIG. 4. The reference numeral 70 thereby designates a router to a network, which is connected via e.g. a 10 BT Ethernet 77 and the public telephone network (PSTN) 72 to a terminal server 71 with a modem. The modem terminal server 71 <can> be a DSL Access Multiplexer (DSLAM). As mentioned, the reference numeral 72 is the public telephone network (PSTN), to which the modem terminal server 71 is connected, for instance via a fiber optic cable 78. Furthermore the public telephone network 79 <sic. 72> or respectively the modem terminal server 71 is connected to a modem 74 of a Personal Computers (PC) 75 typically via a copper wire cable 79 and via the telephone box 73. The reference numeral 79 is thereby the mentioned so-called “last mile” from the distribution station of the telephone network operator to the end user. With his PC the end user 76 can thereby access the router 70 directly by means of the described connection. The ordinary telephone copper lines can be made up, for instance, of 2-2400 pairs of copper wires. Other analog media are also conceivable, however, in particular copper cable with e.g. other wire diameters. It must be explicitly pointed out that not only can the network connections 12 have different diameters or thicknesses 114, 142, 143, 144 in each case, but an individual network connection can be made up of a combination of cables with different wire diameters or thicknesses, i.e. the network connection can comprise a plurality of partial connection elements with cables of differing wire thickness.

If the network consists of a combination of cables with different wire diameters or thicknesses, at least one attenuation distribution factor 2020 is determined 3020 based on a data sample 4020 selected from known data 5000 on network connections, and is transmitted onto a data carrier of the calculating unit 30, the at least one attenuation distribution factor 2020 indicating the ratio of the attenuation of different partial connection elements of a network connection to one another. The attenuation distribution factor 2020 can be determined as a linear factor. The at least one attenuation distribution factor 2020 can also comprise however a non-linear dependency, if this is necessary. In this embodiment example the network connections comprise 0.4 mm and 0.6 mm wire diameters of the copper wire cable as is common on the last mile. Since only two types of cable are used, determining one attenuation distribution factor 2020 is enough. The connecting cables have different electrical characteristics and different attenuation in accordance with their different diameters. It is therefore important for the method that at least the ratio is known, within the necessary degree of accuracy, of the shares of copper cable having 0.4 mm wire diameter and copper cable having 0.6 mm wire diameter of a network connection. The public telephone network is usually engineered such that the total DC impedance(DC: Direct Current) lies within a certain range. This feature can be used to determine when the user lifts the telephone receiver to make a telephone call. If a telephone is used, i.e. a user lifts e.g. is the receiver, the telephone changes its impedance, which change is detected by the central unit. Therefore, in general, more 0.6 mm cable is used for long transmission lines (since the resistance Ω is smaller), and for short distances more 0.4 mm cable is used. Thus the ratio of cable wire thicknesses can be approximated phenomenologically. In particular the calculating unit 30 can also determine 2020, by means of a FIT module, based on known data 5000 of network connections, the function of the attenuation distribution factor in dependence upon the connection length. In this embodiment example, a linear factor was used as the attenuation distribution factor 2020 with

$$\begin{matrix}{D}_{e} \leq 10 \text{:} & {L}_{0.4} ( {D}_{e} ) = \frac{( 10 - l )}{10} \cdot {D}_{e} & {L}_{0.6} ( {D}_{e} ) = \frac{{D}_{e}^{2}}{10} \\ {D}_{e} > 10 \text{:} & {L}_{0.4} ( {D}_{e} ) = 0 & {L}_{0.6} ( {D}_{e} ) = {D}_{e} .\end{matrix}$$

whereby L_{0.4} indicates the share of 0.4 mm cable in km and L_{0.6} the share of 0.6 mm cable, likewise in km, as a function of Dₑ (Dₑ: actual length of the network connection). FIG. 7 shows the dependency Rₜ schematically with t₁ as the cable portion with 0.4 mm wire diameter and t₂ as the cable portion with 0.6 mm wire diameter. The X axis indicates the actual network connection length Dₑ, i.e. its physical length, and the Y axis the shares Rₜ of a respective cable type in percentage. As can be seen, for distances D over 10 km, the portion of 0.6 mm wire copper cable increases to 100%, which means that the network connection consists almost exclusively of 0.6 mm copper cable. Based on the function of the attenuation distribution factor in dependence upon the connection length 2020 and the actual network connection length, the attenuation distribution factor is determined 1020 for the network connection to be classified and is transmitted, assigned to the network connection 12 to be classified, onto a data carrier of the calculating unit 30.

In a further step, data transfer margins 2030 are determined 1030 for determining maximal data throughput rates for different modem types and, assigned to a physical length 13 and cable thickness 141, 142, 143, 144 of a network connection 12, are stored on a data carrier of the calculating unit 30. In addition A power spectrum PSD_{Modem}(f) is measured in dependence upon the transmission frequency f for possible modem types 101, 102, 103, 104 by means of power measuring device 20, and is transmitted onto a data carrier of a calculating unit 30. The power spectrum is also designated as the Power Spectral Density (PSD), and reflects, for a particular bandwidth of a continuous frequency spectrum, the total energy of the particular frequency bandwidth divided by the particular bandwidth. The division by the bandwidth corresponds to a scaling. The PSD is thus a function in dependence upon the frequency f, and is normally indicated in watt per hertz. For power measurement by means of power measuring device 20 at the receiver 11, a simple A/D converter can be used, for instance, the voltage being applied via a resistor. For modulation of digital signals to the line 12 e.g. from end user to the distribution station of the telephone network operator and vice-versa, the most various types of modem can be used. Known in the state of the art are e.g. the xDSL technologies (Digital Subscriber Line), the two main representatives of which are ADSL (Asymmetric Digital Subscriber Line) and SDSL (Symmetric Digital Subscriber Line). Further representatives of the xDSL technology are HDSL (High-data-rate DSL) and VDSL (Very high speed Digital Subscriber Line). The xDSL technologies are highly developed modulation schemes for modulating data on copper lines or other analog media. xDSL technologies are sometimes also referred to as “last mile technologies,” precisely because they usually serve the purpose of connecting the last telephone network distribution station to the end user at the office or at home, and are not used between the individual telephone network distribution stations. xDSL is similar to ISDN (Integrated Services Digital Network) insofar as it can operate over the existing copper lines, and both require a relatively short distance to the next distribution station of the telephone network operator. xDSL offers however much higher transmission rates than ISDN. xDSL reaches data transmission rates of up to 32 Mbps (bps: bits per second) downstream rate (transmission rate during reception of data, i.e. during the modulation) and of 32 kbps to 6 Mbps upstream rate (transmission rate during transmission of data, i.e. during the demodulation), whereas ISDN per channel supports data transmission rates of 64 kbps. ADSL is a technology which has become very popular recently for modulating data over copper lines. ADSL supports data transmission rates of 0 to 9 Mbps downstream rate and 0 to 800 kbps upstream rate. ADSL means asymmetrical DSL, since it supports different downstream and upstream rates. SDSL or symmetrical DSL is called symmetrical, on the other hand, because it supports the same downstream and upstream rates. SDSL permits transmission of data up to 2.3 Mbps. ADSL transmits digital impulses in a high frequency region of the copper cable. Since these high frequencies are not used in normal sound transmission in the acoustic range, (e.g. voices), ADSL can work at the same time, for instance, to transmit telephone conversations over the same copper cables. ADSL is widespread in North America, while SDSL was developed above all in Europe. ADSL as well as SDSL require modems especially equipped therefor. HDSL is a representative of symmetrical DSL (SDSL). The standard for symmetrical HDSL (SDSL) is at present G.SHDSL, known as G.991.2, as developed as an international standard of the CCITT (Comité Consulatif International Téléphonique et Telegraphique) of the ITU (International Telecommunication Union). G.991.2 supports the reception and transmission of symmetrical data streams over a simple copper wire pair with transfer rates between 192 kbps and 2.31 Mbps. G.991.2 was developed such that it comprises the features of ADSL and SDSL, and supports standard protocols such as IP (Internet Protocol), in particular the current versions IPv4 and IPv6 or IPng of the IETF (Internet Engineering Task Force) as well as TCP/IP (Transport Control Protocol), ATM (Asynchronous Transfer Mode), T1, E1 and ISDN. To be mentioned here as the last of the xDSL technologies is VDSL (Very high speed Digital Subscriber Line). VDSL transmits data in the range of 13-55 Mbps over short distances (usually between 300-1500 m) via twisted pair copper cable. With VDSL it applies that the shorter the distance, the higher the transmission rate. As the final part of a network, VDSL connects the office or the home of a user to an adjacent optical network unit, called Optical Network Unit (ONU), which is typically connected to the main optical fiber network (Backbone), for instance of a company. VDSL allows the user access to the network with maximal bandwidth via normal telephone lines. The VDSL standard has not yet been fully established. Thus there are VDSL technologies having a Line Coding Schema based on DMT (Discrete Multitone), DMT being a Multi-Carrier System having great similarity to the ADSL technology. Other VDSL technologies have a Line Coding Schema based on Quadrature Amplitude Modulation (QAM), which, in contrast to DMT, is cheaper, and requires less energy. For this embodiment example the modem types can comprise ADSL and/or SDSL and/or HDSL and/or and/or <sic.> VDSL modem types (101, 102, 103, 104). In particular the possible SDSL modem types (101, 102, 103, 104) can include at least one G.991.2 modem type and/or the ADSL modem types (101, 102, 103, 104) at least one G.992.2 modem type. It is clear, however, that this enumeration is not supposed to apply in any limiting way to the scope of protection of the invention, but that, on the contrary, other modem types are conceivable.

With the calculating unit 30, the attenuation H is determined for different physical lengths 13 and core thicknesses of the cable 141, 142, 143, 144, such as e.g. 0.4 mm and 0.6 mm, of a network connection 12, and the actual signal strengths S(f) at the receiver 11, based on the attenuation H(f) as well as the power spectrum PSD(f), are stored, assigned to the respective physical lengths L 13 and cable wire thicknesses D 141, 142, 143, 144, in a first list on a data carrier of the calculating unit 30. Like the actual signal strength S(f), the attenuation H(f,L,D) is thereby a function in dependence upon the frequencyf. The signal sent from the transmitter 10 is thus PSD_{Modem}(f), while at the receiver an actual signal strength S(f)=PSD_{Modem}(f)H²(f,L,D) is still obtained. In a second list, the noise level N(f) 40 is stored, assigned to the respective physical lengths 13 and cable wire thicknesses 141, 142, 143, 144 of the network connection 12, on a data carrier of the calculating unit 30, the noise level N(f) 40 being determined, based on the power spectrum PSD, by means of the calculating unit 30, in dependence upon at least crosstalk parameters Xtalk type and number of interference sources A. I.e.

$$N ( f ) = {\sum }_{i , Xtalktype} {PSD}_{SModem ( i )} ( f ) Hxp ( f , L , Xtalktype , {A}_{i} )$$

The sum, with the index i, runs over all unwanted modulations (SModem) in dependence upon their Xtalk type, which act on parallel connections of the network connection. PSD_{SModem(i)} is the power spectrum of the i^{th} Smodem. Hxp is the attenuation in dependence upon the crosstalk. As mentioned, the crosstalk problem is the physical phenomenon occurring with modulation of data over a copper cable. Adjacent copper cable wires inside a copper cable obtain, by way of electromagnetic interaction, partial signals pairwise which are generated by modems. This leads to xDSL modems, which are carried assigned on adjacent wires, interfering with one another. Crosstalk as the physical effect is almost negligible for ISDN (frequency range up to 120 kHz), but becomes important however for e.g. ADSL (frequency range up to 1 MHz) and becomes a decisive factor for VDSL (frequency range up to 12 MHz). As described, the conventional telephone copper lines consist of 2 to 2400 copper wires. In order to be able to use four pairs, for example, the data stream at the transmitter is divided up into a multiplicity of parallel data streams and recombined again at the receiver, which increases the actual data throughput by a factor of 4. This would permit a data transmission with up to 100 Mbps. In addition, in the case of 4 pairs of copper wires, the same four pairs of wire could be used to transport the same quantity of data simultaneously in the opposite direction. The bidirectional data transmission over each pair of copper wire doubles the information capacity which can be transmitted. This increases in this case the data transmission rate by eight times compared to conventional transmissions, in which two pairs are used for one direction in each case. For data transmission as described above, crosstalk noise is a greatly limiting factor. As crosstalk types a distinction is made between near-end crosstalk (Next) 51, which describes the undesired coupling of the signal 50 of the transmitter 10 at one end to the signals 50 at the receiver 11 at the same end, and far-end crosstalk (FEXT) 52, which describes the undesired coupling of signals 50 during the transmission to the receiver 11 at the other end, the signals 50 being coupled during the transmission to signals 50 of adjacent copper wire pairs and turning up at the receiver 11 as noise (see FIG. 1). Normally it is assumed that NEXT 51 has only one near-end interference source. Xtalk type is thus dependent upon the location and the stream (up/down), i.e. Xtalk type (stream, location). If there are more than two copper wires, which is usually the case (typically there are between 2 and 2400 wires), then the pairwise coupling described above is no longer true. E.g. for the case where four pairs of wire are used at the same time, there are consequently now three unwanted interference sources which couple with their energy to the signal 50. For A, A=3 applies in this case. The same applies for FEXT crosstalk 52.

By means of a Gaussian transformation module 31, the calculating unit 30 determines the data transfer margins based on the actual signal strength strengths S(f) of the first and the corresponding noise level R(f) of the second list for different data transmission modulations and/or modulation codings for a predefined bit rate, and stores the data transfer margins, assigned to the respective physical lengths 13 and cable wire thicknesses 141, 142, 143, 144 of the network connection 12, on a data carrier of the calculating unit 30. With the actual signal strengths S(f) of the first list and the noise level N(f), the signal S to noise R <sic. N> ratio SNR (Signal to Noise Ratio) can be calculated by means of the calculating unit 30, whereby:

$$SNR ≅ exp ( T {\int }_{- 1 / 2 T}^{1 / 2 T} ln ( \frac{{\sum }_{n} \vert S ( f + n / T ) {\vert}^{2}}{{\sum }_{n} N ( f + n / T )} ) ⅆ f )$$

This formula applies only for CAP, 2B1Q and PAM modulation, not however for DMT modulation. DMT will be described more closely further below. T is thereby the symbol interval or half the inverse of the Nyquist frequency. The Nyquist frequency is the highest possible frequency that can still be sampled precisely. The Nyquist frequency is half the sampling frequency, since unwanted frequencies are generated when a signal is sampled whose frequency is higher than half the sampling frequency. n is the summing up index. In practice it normally suffices for n to run from −1 to 1. If this does not suffice, further maxima 0, ±1/T, ±2/T etc. can be included until the desired precision is reached. The data transfer margins depend upon the data transmission modulations and/or modulation codings, as has been mentioned further above. In this embodiment example we shall show the dependency, for instance, for HDSL modems 2B1Q modulation (2 Binary, 1 Quaternary) and CAP modulation (Carrierless Amplitude/Phase Modulation) as an example for ADSL DMT modulation (Discrete Multitone Technology) and with respect to the modulation codings for trellis-coded signals. However, it is also clear that the method and system according to the invention also applies, without further ado, to other data transmission modulations and/or modulation codings such as e.g. PAM (Pulse Amplitude Modulation) etc. 2B1Q modulation as well as CAP modulation is used with HDSL modems, and has a predefined bit rate. DMT modulation is used with ADSL modems, and has, on the other hand, a variable bit rate. CAP and DMT have used the same fundamental modulation technology: QAM (Quadrature Amplitude Modulation), although this technology is employed differently. QAM makes it possible for two digital carrier signals to occupy the same transmission bandwidth. Two independent so-called message signals are thereby used to modulate two carrier signals having an identical frequency, but differing in amplitude and phase. QAM receivers can distinguish whether a low or a high number of amplitude and phase states are required in order to obviate noise and interference e.g. on a copper wire pair. 2B1Q modulation is also known as “4 Level Pulse Amplitude Modulation” (PAM). It uses two volt levels for the signal pulse and not, such as e.g. AMI (Alternate Mark Insertion), one level. Since positive and negative level distinction is also made, one obtains a 4 level signal. The bits are combined finally into twos in each case, which pairs each correspond to a volt level (therefore 2 bit). The required signal frequency for transmitting the same bit rate, as with bipolar AMI, is thereby halved with 2B1Q. With HDSL modem with 2B1Q or CAP modulation, there exists the following dependency of the data transfer margins with respect to the SNR:
M_{c}=SNR/ξ

whereby ξ can be determined as a function of the error rate (Symbol Error Rate) εₛ. For LAN (IP) an error rate of εₛ=10⁻⁷ usually suffices, i.e. each 10⁷ bit is wrongly transmitted on the average. Companies typically require a εₛ=10⁻¹² for their company networks. If, for instance, the εₛ approaches the order of magnitude of the data packet size transmitted (e.g. 10⁻³), that would mean conversely that each packet has to be transmitted twice on the average until it arrive correctly. For the 2B1Q modulation there applies for εₛ for example:

$$\begin{matrix}{ɛ}_{s} = 2 ( 1 - \frac{1}{M} ) \cdot {G}_{c} ( \sqrt{\frac{3 * ξ}{{M}^{2} - 1}} ) for uncoded signals and \\ {ɛ}_{s} = 2 ( 1 - \frac{1}{M / 2} ) \cdot {G}_{c} ( \sqrt{\frac{3 * ξ * {10}^{0.4}}{{( M / 2 )}^{2} - 1}} ) for trellis \text{-} coded signals ,\end{matrix}$$

while for the CAP modulation there applies:

$$\begin{matrix}{ɛ}_{s} = 4 ( 1 - \frac{1}{M} ) \cdot {G}_{c} ( \sqrt{\frac{3 ξ}{{M}^{2} - 1}} ) for uncoded signals and \\ {ɛ}_{s} = 4 ( 1 - \frac{1}{M / \sqrt{2}} ) \cdot {G}_{c} ( \sqrt{\frac{3 ( {ξ10}^{0.4} )}{{M}^{2} / 2 - 1}} ) for trellis \text{-} coded signals .\end{matrix}$$

for both codings G_{c} is a complementary Gauss function with:

$${G}_{c} ( x ) := {\int }_{x}^{∞} \frac{1}{\sqrt{2 π}} {ⅇ}^{- {x}^{′ 2} / 2} ⅆ {x}^{′}$$

and for the 2B1Q modulation M is the moment number with M=4 for 2B1Q, while for the CAP modulation M is the constellation magnitude M×M. T is, as above, the symbol interval or half the inverse of the Nyquist frequency. For ADSL modems with DMT modulation, the dependency is different. As mentioned, ADSL has a variable bit rate. This displays itself likewise in M_{c}. Applicable is:

$${M}_{c} = {x}_{ref} \frac{{2}^{( \int lo {g}_{2} ( 1 + \frac{ξ ( f )}{{x}_{ref} Γ} ) ⅆ f ) / Δ f} - 1}{{2}^{D / Δ f} - 1}$$

whereby ξ(f) is the signal-to-noise ration S(f)/N(f). x_{ref} is a reference margin which in this embodiment example has been typically selected as 6 dB, i. e. x_{ref}=10^{0.6}. Other values for reference margins are conceivable, however. Δf is the entire frequency width or respectively the entire frequency band used for the transmission. The integration is executed via the frequency. D is the bit rate, for instance in b/s (bits/seconds). Γ is a correction factor. In this embodiment example Γ is situated for instance at Γ=9.55. The integration is carried out in this embodiment example via the frequency f. Analogously, it can also be carried out over time or another physical value, the formula above having to then be adapted accordingly.

In general, the data transfer margins obtained such as above do not correspond to experiment. Therefore the calculating unit 30 determines the actual data transfer margins by means of at least one correction factor based on the stored data transfer margins. The correction factor for this embodiment example has been selected such that a sufficient correspondence is achieved between the obtained data transfer margins and the actual data transfer margins. Assumed to be sufficient here was e.g. +/−3 dB, other values also being conceivable, however. To achieve this maximal deviation of +/−3 dB, two parameters are determined. Mᵢₘₚ takes into account the good or poor implementation of a modem by the manufacturer. Mᵢₘₚ was introduced based on the fact that same modems with comparable hardware and same data transmission modulations and/or modulation codings, but however from different manufacturers, deliver different results during translation of the analog signal into a digital signal and vice-versa, which affects their maximal bit rate or their maximal range for a particular network connection. This must be corrected for the data transfer margins. Introduced as the second parameter was Nᵢₙₜ. Nᵢₙₜ takes into account the quantization noise in the modem (analog-to digital conversion), as well as a possible poor adaptation of the equalizer during the transmission. If a transmission takes place between a transmitter 10 and a receiver 11, the equalizer in the modem adapts the transmission rate to the conditions of the network connection such as e.g. the line attenuation, phase distortion, etc. by means of a training sequence, which are <sic. is> sent back and forth between the two communicating modems. A poor adaptation by the equalizer leads to a distortion of the results and must be corrected. For linear equalizers, the following formula can be used, for example:

$$\begin{matrix}{SNR}_{{LinearE}_{q}} = {( T {\int }_{- 1 / 2 T}^{1 / 2 T} \frac{ⅆ f}{{X}_{s} ( f )} )}^{- 1} \\ with \\ {X}_{s} ( f ) = {\sum }_{n} \frac{{\vert {S}_{e} ( f + n / T ) \vert}^{2}}{{N}_{e} ( f + n / T )} + 1\end{matrix}$$

whereby SNR_{linearEq} is the signal-to-noise ratio, Sₑ the signal which the equalizer receives, Nₑ the noise and f the frequency. For a Decision Feedback Equalizer (DFE), the following formula can be used:

$$\begin{matrix}{SNR}_{DFE} = exp ( T {\int }_{- 1 / 2 T}^{1 / 2 T} ln ( {X}_{s} ( f ) ) ⅆ f ) \\ with \\ {X}_{s} ( f ) = {\sum }_{n} \frac{{\vert {S}_{e} ( f + n / T ) \vert}^{2}}{{N}_{e} ( f + n / T )} + 1\end{matrix}$$

whereby again SNR_{linearEq} is the signal-to-noise ratio, Sₑ is, as above, the signal which the equalizer receives, Nₑ the noise and f the frequency. For determination of the SNR_{DFE}, the calculating unit 30 can use e.g. the following approximation:

$${SNR}_{DFE} ≅ exp ( T {\int }_{- 1 / 2 T}^{1 / 2 T} ln ( \frac{{\sum }_{n} \vert {{S}_{e} ( f + n / T \vert}^{2}}{{\sum }_{n} {N}_{e} ( f + n / T )} ) ⅆ f )$$

Thus it follows for the actual data margins: S(f)=PSD_{Modem}(f)H²(f,L,D) as previously. The noise is corrected as follows:

$$N ( f ) = {\sum }_{i} {PSD}_{SModem ( i )} ( f ) \cdot {Hxp}^{2} ( f , L , D , {xtalktype}_{i} , {n}_{i} ) + {N}_{int}$$

In the calculating unit 30 the correction can be implemented in a module using hardware or software. It is important to point out that with such a module, based on the correction Nᵢₙₜ, a variable noise factor is introduced which can take into consideration, for example, equalizer harmonization, etc. This cannot be found as such in the state of the art, and is among the substantial advantages of the invention, among other things. The actual data transfer margins M_{eff} become <have been given> through M_{eff}=M_{c}−Mᵢₘₚ, which is taken into account in addition to Nᵢₙₜ, as mentioned above. The correct values for M_{c} and Nᵢₙₜ can be obtained by the calculating unit 30 in the comparison with experimental data. Typically the calculating unit 30 must have access for this purpose to data from various experiments in order to be able to determine the parameters correctly within the desired deviation. By means of the correction factors, which therefore comprise an average deviation of the stored data transfer margins with respect to the actual data transfer margins, the actual data transfer margins described above are determined and stored, likewise assigned to the respective physical lengths L 13 and cable wire thicknesses D 141, 142, 143, 144 of the network connection 12, on a data carrier of the calculating unit 30. It is to be pointed out that the correction factors do not necessarily have to be linear factors, i.e. constants, but can also just as well comprise instead correction functions with a non-linear dependency. Depending upon the application, more complex deviations of the experimental data can thereby also be taken into account. Finally, by means of the stored matrices with the data transfer margins, the calculating unit 30 determines the data transfer margin for a particular network connection 12 based on the stored actual transfer margins with reference to the known physical length 13 of the network connection 12 to be determined between the transmitter 10 and the receiver 11. As mentioned several times, the data transfer margins are indicated in dB. The modem runs typically for values >0 dB, while for values <0 dB it does not run. To guarantee a good, secure operation, it can make sense to select e.g. 6 dB as lower limit. In general, other data transfer margins are also suitable as lower limit, however, e.g. values between 3 dB and 9 dB. As follows from the above indications, instead of matrices with data transfer margins, correspondingly matrices with bit rates for various network connections, e.g. for a data transfer margin of 6 dB, can be determined for ADSL modems, by means of the same configuration. Thus it follows for determining the matrices with bit rates 6 dB=M_{eff}. In the case of the HDSL modems, this does not make any sense insofar as the codings with HDSL, such as e.g. 2B1Q or CAP, work with a constant bit rate, here e.g. 2.048 Mb/s. The reason for this difference with respect to the ADSL modems is that HDSL systems are only designed for a point of access with higher bit rate, and concern only security (SNR). FIG. 3 shows the transmission distance of the network connection in dependence upon the transmission rate (bit rate) for ADSL modems. The reference numerals 60 and 61 thereby designate different noise environments. As described above, the bit rates have been shown based on the stored matrices or respectively lists.

Based on the stored matrices or respectively lists 2030 of the data transfer margins/bit rates, the data transfer margins/bit rates are determined 1030 for the network connection to be classified and are transmitted, assigned to the network connection 12 to be classified, onto a data carrier of the calculating unit 30.

Based on the actual network connection length, attenuation distribution factor 2020 and the data transfer margins 2030, the network connection to be classified can be classified 1040 according to its maximal data throughput rate by means of calculating unit 30. The classification can comprise in particular the maximal possible data transmission rate for the network connection to be classified. The results of the classification can be made available 1050 to a user via a screen, a printer module or other output unit. In particular, via the device, connection to the Internet can be made via a graphic interface, for example, whereby it can be easily determined by any telephone subscriber of a telephone network service provider whether his point of access (e.g. at home) is suitable for a specific network connection or not.

### List of Reference Numerals

10 transmitter (transceiver)
101/102/103/104 different modem types (ADSL, HDSL etc.)
11 receiver
12 network connection (transmission line)
13 physical length of the network connection
141/142/143/144 cable thickness
20 power measuring device
30 calculating unit
31 Gaussian transformation module
40 noise
50 signal
51 Near-End Crosstalk (NEXT)
52 Far-End Crosstalk (FEXT)
60/61 different noise environments
70 router
71 modem terminal server
72 public telephone network (PSTN)
73 telephone point of access or respectively telephone box
74 modem
75 personal computer
76 end user
77 10 BT Ethernet
78 optical fiber connection
79 copper line (analog with HDSL or ADSL or digital with ISDN)
1000 input of the coordinates of the network connection to be classified
1010 determination of the actual physical length of the network connection to be classified
1020 determination of the attenuation distribution factor of the network connection to be classified
1030 determination of the data transfer margin of the network connection to be classified
1040 classification of the network connection
1050 output of the classification
2011 distance factors
2012 safety factor
2020 attenuation distribution factor
2030 data transfer margins
3010 determination of the distance factors
3020 determination of the attenuation distribution factor
3030 determination of the data transfer margins
4010 selection of the data sample for determination of the distance factors
4020 selection of the data sample for determination of the attenuation distribution factor
4030 determination of the power spectra PSD_{Modem}(f)
5000 data sample with connection to known characteristics

1-28. (Canceled).

29. A method for classifying network connections, geographical coordinates of a transmitter and a receiver of a network connection to be classified being known, comprising:
determining, by a calculating unit, based on known data network connections, one or more distance factors, assigned to a determinable probability, and transmitting the one or more distance factors to a data carrier of the calculating unit, the distance factors indicating an actual network connection length in dependence upon air distance, and the determinable probability whether a determined network connection length is shorter or longer than its actual network length is established by a safety factor;
determining, based on the one or more distance factors, the safety factor, and the geographic coordinates of the transmitter and of the receiver of the network connection to be classified, the actual network connection length by the calculating unit, and transmitting the actual network connection length, assigned to the network connection to be classified, onto the data carrier of the calculating unit;
determining at least one attenuation distribution factor based on known data of network connections, and transmitting the at least one attenuation distribution factor onto the data carrier of the calculating unit, the at least one attenuation distribution factor indicating a ratio of attenuation of different partial connection elements of a network connection in relation to one another;
determining data transfer margins for determining maximal data throughput rates for different modem types and storing the data transfer margins, assigned to a physical length and cable thickness of a network connection, on the data carrier of the calculating unit, power spectra for the modem types being measured by a power measuring device, actual signal strengths and corresponding noise level being determined by the calculating unit based on the power spectra, and the data transfer margins for a predefined bit rate being determined by a Gaussian transformation module based on the signal strengths and the noise level for different data transmission modulations and/or modulation codings; and
classifying, based on the actual connection length, the attenuation distribution factor, and the data transfer margin, the network connection corresponding to its maximal data throughput rate by the calculating unit.

30. A method according to claim 29, wherein a gradient factor and an abscissa are determined as distance factors by the calculating unit, a linear dependency between air distance and actual network connection length being determined.

31. A method according to claim 29, wherein the distance factors are determined by the calculating unit as a parameter of a polynomial of at least 2^{nd} order.

32. A method according to claim 29, wherein using the safety factor a probability is selected of between 0.85 and 0.95.

33. A method according to claim 29, wherein the safety factor has a value of between 700 and 800.

34. A method according to claim 29, wherein by the attenuation distribution factor a linear dependency of the attenuations with respect to one another is determined.

35. A method according to claim 29, wherein the calculating unit determines corrected data transfer margins, based on the stored data transfer margins, by at least one correction factor, and the corrected data transfer margins, assigned to the respective physical lengths and cable wire thicknesses of the network connection, are stored on the data carrier of the calculating unit, the at least one correction factor comprising an average deviation of the stored data transfer margins to the actual data transfer margins and/or an equalizer factor for correction of equalizer adjustment.

36. A method according to claim 35, wherein the correction factor reflects a non-linear dependency with respect to the physical lengths and/or cable wire thicknesses.

37. A method according to claim 29, wherein the noise levels are determined based on the power spectra by the calculating unit in dependence upon at least crosstalk parameters and number of interference sources.

38. A method according to claim 29, wherein the power spectrum is measured in dependence upon transmission frequency for ADSL, and/or SDSL, and/or HDSL, and/or VDSL modem types.

39. A method according to claim 38, wherein the possible SDSL modem types comprise at least one G.991.2 modem type and/or the ADSL modem types comprise at least one G.992.2 modem type.

40. A method according to claim 29, wherein by the Gaussian transformation module the data transfer margins are determined for at least the data transmission modulations 2B1Q, and/or CAP, and/or DMT, and/or PAM.

41. A method according to claim 29, wherein by the Gaussian transformation module the data transfer margins are determined for at least trellis modulation coding.

42. A method for classifying network connections, geographic coordinates of a transmitter and a receiver of a network connection to be classified being known, comprising:
determining, by a calculating unit, based on known data of network connections, one or more distance factors, assigned to a determinable probability, and transmitting the one or more distance factors onto a data carrier of the calculating unit, the distance factors indicating actual network connection length in dependence upon air distance, and the determinable probability whether a determined network connection length is shorter or longer than its actual network length being established by a safety factor;
determining, based on the distance factors, the safety factor, and the geographic coordinates of the transmitter and of the receiver of the network connection to be classified, the actual network connection length by the calculating unit, and transmitting the actual network connection length, assigned to the network connection to be classified, onto the data carrier of the calculating unit;
determining at least one attenuation distribution factor based on known data of network connections, and transmitting the at least one attenuation distribution factor onto the data carrier of the calculating unit, the at least one attenuation distribution factor indicating a ratio of attenuation of different partial connection elements of a network connection in relation to one another;
determining bit rates for determining maximal data throughput rates for different modem types, assigned to a physical length and cable thickness of a network connection, and storing the bit rates on the data carrier of the calculating unit, power spectra being measured for the modem types by a power measuring device, actual signal strengths, and corresponding noise levels being determined by the calculating unit based on the power spectra, and the bit rates for a predefined data transfer margin being determined by a Gaussian transformation module based on the signal strengths and the noise level for different data transmission modulations and/or modulation codings; and
classifying, based on the actual network connection length, the attenuation distribution factor, and the data transfer margins, the network connection to be classified by the calculating unit according to its maximal data throughput rate.

43. A method according to claim 42, wherein a gradient factor and an abscissa are determined as distance factors by the calculating unit, a linear dependency between air distance and actual network connection length being determined.

44. A method according to claim 42, wherein by the calculating unit the distance factors are determined as parameters of a polynomial of at least 2^{nd} order.

45. A method according to claim 42, wherein using the safety factor a probability of between 0.85 and 0.95 is selected.

46. A method according to claim 42, wherein the safety factor has a value between 700 and 800.

47. A method according to claim 41, wherein bit rates for a data transfer margin between 3 and 9 dB are determined by the Gaussian transformation module.

48. A method according to claim 42, wherein bit rates for a 6 dB data transfer margin are determined by the Gaussian transformation module.

49. A method according to claim 42, wherein the calculating unit determines corrected bit rates, based on the stored bit rates by at least one correction factor, assigned to the respective physical lengths and cable wire thicknesses of the network connection, and stores the corrected bit rates on the data carrier of the calculating unit, the correction factor comprising an average deviation of the stored bit rates with respect to the actual bit rates and/or an equalizer factor for correction of equalizer adjustment.

50. A method according to claim 49, wherein the at least one correction factor reflects a non-linear dependency with respect to the physical lengths and/or cable wire thicknesses.

51. A method according to claim 42, wherein the noise levels are determined based on the power spectra by the calculating unit in dependence upon at least crosstalk parameters and number of interference sources.

52. A method according to claim 42, wherein the power spectrum is measured according to transmission frequency for ADSL, and/or SDSL, and/or HDSL, and/or VDSL modem types.

53. A method according to claim 52, wherein the SDSL modem types comprise at least one G.991.2 modem type and/or the ADSL modem types comprise at least one G.992.2 modem type.

54. A method according to claim 42, wherein bit rates for at least the data transmission modulations 2B1Q, and/or CAP, and/or DMT, and/or PAM are determined by the Gaussian transformation module.

55. A method according to claim 42, wherein bit rates for at least trellis modulation coding are determined by the Gaussian transformation module.

56. A device for classifying network connections, geographic coordinates of a transmitter and a receiver of a network connection to be classified being known, comprising:
a calculating unit configured to determine and store one or more distance factors of a determinable probability based on known data of network connections, the distance factors indicating an actual network connection length in dependence upon air distance, and determinable probability whether a determined network connection length is shorter or longer than its actual network length being established by a safety factor, wherein the calculating unit comprises means for determining and storing at least one attenuation distribution factor based on known data of network connections, the at least one attenuation distribution factor indicating a ratio of attenuation of different partial connection elements of a network connection in relation to one another;
a power measuring device configured to measure power spectra for different modem types;
means for determining actual signal strengths and corresponding noise levels based on the power spectra; and
a Gaussian transformation module configured to determine and store data transfer margins based on the signal strengths and the noise levels for different data transmission modulations and/or modulation codings and for a predefined bit rate.
